(19) United States
(12) Patent Application Publication
(10) Pub. No.: US 2026/0113239 A1
(43) Pub. Date: Apr. 23, 2026

(54) Fingerprinting Internet-Connected Devices

(71) Applicant: The Regents of The University of Michigan, Ann Arbor, MI (US)

(72) Inventors: Armin SARABI, Ann Arbor, MI (US); Mingyan LIU, Ann Arbor, MI (US)

(73) Assignee: The Regents of The University of Michigan, Ann Arbor, MI (US)

(21) Appl. No.: 19/353,814

(22) Filed: Oct. 9, 2025

Related U.S. Application Data
(60) Provisional application No. 63/708,301, filed on Oct. 17, 2024.

(51) Int. Cl. H04L 41/0893; H04L 41/12; H04L 41/16

(52) U.S. Cl. CPC H04L 41/0893; H04L 41/12; H04L 41/16

(57) ABSTRACT

A computer-implemented method is presented for fingerprinting network services. The method includes: receiving a plurality of banners, where each banner contains text data describing a network service accessible at a port on a networked device in a computer network; generating a set of embeddings from the plurality of banners using a large language model, where each embedding in the set of embeddings represents one or more banners from the plurality of banners clustering the embeddings based on distance between the embeddings using a clustering method, thereby forming a group of clusters; and generating a fingerprint for a given cluster in the group of clusters, where the fingerprint is a text string may come from a given banner and identifies a network service or product accessible in the computer network.

### CROSS-REFERENCE TO RELATED APPLICATIONS

This application claims the benefit of U.S. Provisional Application No. 63/708,301, filed on Oct. 17, 2024. The entire disclosure of the above application is incorporated herein by reference.

### GOVERNMENT CLAUSE

This invention was made with government support under 2012001 awarded by the National Science Foundation. The government has certain rights in the invention.

### FIELD

The present disclosure relates to method for fingerprinting network devices.

### BACKGROUND

The proliferation of Internet-connected devices has given rise to network scanning techniques for giving visibility into the public Internet. Projects and entities, such as Censys and Shodan, perform regular Internet-wide scans and record snapshots of visible devices on the Internet across many ports. These measurements are widely used for a variety of purposes, including to detect and fingerprint networks, study trends, examine security events, and enable various machine learning analysis. However, these Internet-wide scans essentially consist of raw information obtained from protocol handshakes (including banner grabs) with low label/feature coverage, e.g., to identify the underlying hardware/software products, or to facilitate automated analysis. This poses a challenge for researchers, network administrators, and security practitioners that utilize scan data, as one needs to develop their own data processing pipeline to filter for relevant information and make sense of the raw data.

At the same time, recent advances in deep learning have led to the development of large language models (LLMs) for complex text analysis. In particular, transformer-based models, such as BERT and GPT, have been successfully applied to many natural language processing (NLP) tasks such as language modeling, translation, text classification, and clustering, achieving state-of-the-art performance.

Interestingly and crucially, the large amount of text data generated by Internet scans and the text-based nature of the scan data make them suitable for training large language models. Motivated by this observation, this disclosure trains and evaluates an LLM on snapshots obtained from Internet scans, distilling raw text into general-purpose embeddings that are amenable to downstream machine learning tasks and analysis. Previous work has used deep learning models to generate numerical embeddings to characterize Internet hosts, but these methods relies on first converting the scan data into binary vectors which are then used for training. By contrast, this disclosure presents the first model that is directly trained on raw text without an intermediate feature extraction step (e.g., the bag-of-words model). It turns out that this allows the model to learn the underlying structure of scan data and support more interpretable analysis (e.g., by directly annotating text).

This section provides background information related to the present disclosure which is not necessarily prior art.

### SUMMARY

This section provides a general summary of the disclosure, and is not a comprehensive disclosure of its full scope or all of its features.

A computer-implemented method is presented for fingerprinting network services. The method includes: receiving a plurality of banners, where each banner contains text data describing a network service accessible at a port on a networked device in a computer network; generating a set of embeddings from the plurality of banners using a large language model, where each embedding in the set of embeddings represents one or more banners from the plurality of banners clustering the embeddings based on distance between the embeddings using a clustering method, thereby forming a group of clusters; and generating a fingerprint for a given cluster in the group of clusters, where the fingerprint is a text string may come from a given banner and identifies a network service or product accessible in the computer network.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an example pipeline for generating fingerprints for network devices.

FIG. 2 is an example of a HTTP banner with grayed out areas denoting portions predicted to be dynamic.

FIG. 3 are graphs showing distribution of L−2 distances between embeddings of matching and random banner pairs for our proposed contrastive model (left) and a vanilla masked language model (right). Contrastive training results in a much more distinctive difference (roughly three orders of magnitude) between the two sets. Note that the x-axis has a logarithmic scale.

FIG. 4 are examples of banner pairs (snapshots obtained one month apart from the same IP address and port) exhibiting major configuration changes (top), and corresponding to different server products (bottom). The pair at the top has a distance of 0.3 in the embedding space, while the pair at the bottom has a distance of 2.3.

FIG. 5 are example hardware/software fingerprints generated from different HTTP headers and not captured in the Recog database. This demonstrates the ability of the automated fingerprint generation technique to complement existing databases and to help keep fingerprints up-to-date.

Corresponding reference numerals indicate corresponding parts throughout the several views of the drawings.

### DETAILED DESCRIPTION

Example embodiments will now be described more fully with reference to the accompanying drawings.

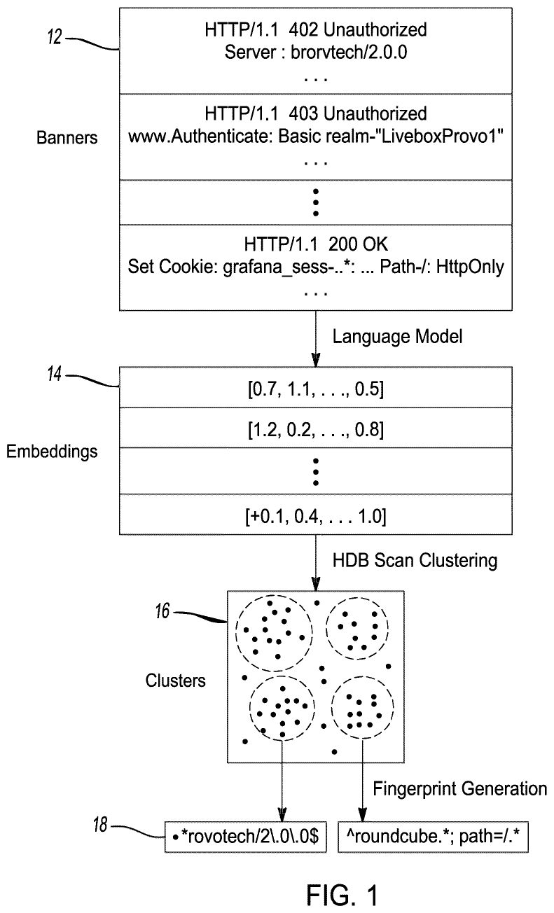

FIG. 1 depicts an example technique for fingerprinting network devices in a computer network. As a starting point, a plurality of banners are received at 12 by a computer processor. Each banner contains text data describing a network service or product accessible at a port on a networked device in a computer network. The banners may be acquired using banner grabbing which is a known technique in the art. Other techniques for acquiring banner data are also contemplated by this disclosure.

Next, embeddings are generated at 14 from the plurality of banners, preferably using a large language model. Each embedding in the set of embeddings represents one or more banners from the plurality of banners. That is, an embedding may represent one banner or a collection of banners. The embeddings in the set of embeddings are then clustered at 16 based on the distance between embeddings using a clustering method, thereby forming a group of clusters. In an example embodiment, the embeddings are clustered using a density-based spatial clustering of applications with noise (DBSCAN) method. Other clustering methods also fall within the scope of this disclosure.

Lastly, a fingerprint is generated at 18 for a given cluster in the group of clusters. The fingerprint is a text string may come from a given banner and identifies a network service or product accessible in the computer network. Fingerprints are also generated for the other clusters in the group of clusters. To generate additional fingerprints from the banners, a parameter of the clustering method (e.g., epsilon) may be changed and the steps are repeated using the newly defined clusters. In this way, the embeddings are clustered in different ways which may in turn identify different network services or products described in the banners. Each of these steps is described in more detail below.

For a proof of concept, six different snapshots were used from the Censys Universal Internet Dataset, corresponding to the first Tuesday in each month between July and December 2023. Currently, Censys contains scans of the entire IPv4 space across 107 protocols and over 3500 ports. From each snapshot, non-empty service banners are collected, ignoring services that are flagged as truncated. To reduce the size of the dataset, one can subsample 10% of all IP addresses from each snapshot, ensuring the same selection of IPs across all snapshots. This results in a total of ˜260 million banners across all snapshots.

To be able to feed text data to a transformer-model, it first needs to be split into tokens. For example, BERT is a pre-training of deep bidirectional transformers for language understanding as described by Devlin et al in “BERT: Pre-training of deep bidirectional transformers for language understanding” arXiv:1810.04805 (2018). BERT uses subword tokens to limit its vocabulary size while minimizing unknown tokens, generated when encountering sequences not seen during training of the tokenizer. In another example, ROBERTa uses a byte-level, byte-pair encoding (BPE) tokenizer, which has the advantage of making tokenization lossless by falling back to single-byte tokens when necessary to prevent producing unknown tokens. In the example embodiment, ROBERTa is used as a tokenizer due to its losslessness (especially since scans can contain a combination of text and binary data, increasing the likelihood of unknown tokens if a non byte-level tokenizer is used). Further details regarding ROBERTa may be found in “ROBERTa: A robustly optimized BERT pretraining approach” arXiv:1907.11692 (2019). Note, however, that a pretrained ROBERTa tokenizer would not be optimal due to the different nature of the data. Therefore, the tokenizer is retrained with 50,000 tokens on 100 million randomly selected samples from the dataset, and used for the remainder of this disclosure to encode banners into a sequence of tokens.

To generate embedding from the banners, a transformer model is trained as further described below. In an example embodiment, a masked language model (MLM) is trained using the banners from the dataset noted above. MLMs are trained by randomly masking a small percentage of tokens, and then attempting to infer the masked tokens based on the context provided by surrounding text. This incentivizes the model to learn semantic relations, resulting in context-aware embeddings. Note that MLMs are bidirectional models, meaning that a token embedding depends on both preceding and following tokens. MLMs are typically the first step in training a large language model, which are then fine-tuned on downstream tasks, e.g., for classification or machine translation. As proof of concept, a ROBERTa model was trained with 256-dimensional embeddings, 4 layers, 4 attention heads, and an intermediate layer size of 1024. This model is trained for 100,000 iterations with batch size of 1024 and a learning rate of 0.0002, randomly masking 15% of all tokens during training. The above masked language model is trained on all protocols recorded in the Censys dataset, making it a great starting point for studies that aim to process this type of data. However, models and analysis in the remainder of this disclosure only focus on banners from the HTTP protocol, which constitute ˜70% of banners in the dataset.

A banner can contain dynamic sections (i.e., variables) that vary over time, including timestamps and randomized IDs regenerated every time a host is probed. It is desirable for banner embeddings to be invariant to these changes. Therefore, a supervised contrastive loss is used to incentivize the model to generate embeddings that remain stable over time, while maximizing the distance between embeddings of different services. To this end, first identify banner pairs corresponding to the same IP address and port from two consecutive snapshots (with the associated snapshot denoted using k∈{1, 2} from hereon), which is a strong indication that they originate from the same device. Next, identify common parts in both banners; this is done by first splitting each banner into its respective headers, and then performing common substring matching to identify common parts in each header. One can ignore individual matches less than 3 characters long, and discard pairs where the sum length of all matches is less than 11 tokens. The latter filters out pairs that likely correspond to different devices/services, with the threshold selected by manual inspection of a random set of pairs.

Formally, denote by

$${t}_{i , j}^{( k )} , 1 \leq j \leq {l}_{i}^{( k )}$$

the tokenized sequence associated with a banner, with 1≤i≥n specifying a banner pair, and

$${l}_{i}^{( k )}$$

specifying the length of a tokenized sequence. Then generate labels

$${y}_{i , j}^{( k )} ∈ \{ 0 , 1 \} ;$$

indicating whether a token has been matched between two banners as previously described. Use these labels to train a token classification model that can predict stable sections in a banner, which in turn carry important information about the underlying service.

To generate banner embeddings, one needs to aggregate the embeddings of all tokens in a sequence. Usually, the embedding of the first token (typically a special beginning-of-sentence token) or the average embedding of all tokens is used as the embedding of the entire sequence. Note, however, that a token with a label of zero should not contribute to the banner embedding, since it can be perceived as noise and does not contain information relevant to the underlying host. Therefore use the weighted average of all token embeddings, with the predicted labels as weights, resulting in embeddings that are robust to the noise present in each banner. Take

$${e}_{i , j}^{( k )} ∈ and 0 \leq {\hat{y}}_{i , j}^{( k )} \leq 1$$

to be the m-dimensional token embeddings (from the last layer of the transformer model) and the predicted labels, respectively. Define the banner embedding

$${\overline{e}}_{i}^{( k )}$$

as follows (note that the embedding is normalized to have an l₂-norm of one, which will be justified shortly).

$${\overline{e}}_{i}^{( k )} := \frac{{e}_{i}^{( k )}}{{‖ {e}_{i}^{( k )} ‖}_{2}} , {e}_{i}^{( k )} := \frac{{\sum }_{j} {y}_{i , j}^{( k )} {e}_{j , j}^{( k )}}{{\sum }_{j} {\hat{y}}_{{i}_{1} j}^{( k )}}$$

While the above makes embeddings invariant to dynamic portions of a banner (i.e., with a label of 0), token embeddings for static portions (i.e., those with a label of 1) are not guaranteed to remain constant due to their context-aware nature, which may in turn cause embeddings to drift over time. Therefore modify the loss function to force the model to generate similar embeddings for matching pairs, while maximizing distances between randomly selected pairs as follows:

$$ℒ = - \frac{1}{{n}_{t}} {\sum }_{i , j , k} {y}_{i , j}^{( k )} log {\hat{y}}_{i , j}^{( k )} + ( 1 - {y}_{i , j}^{( k )} ) ( 1 - log {\hat{y}}_{i , j}^{( k )} ) + \frac{1}{n} {\sum }_{i} {‖ {\overline{e}}_{i}^{( 1 )} - {\overline{e}}_{i}^{( 2 )} ‖}_{2} - \frac{1}{n} {\sum }_{i} {‖ {\overline{e}}_{i}^{( 1 )} - {\overline{e}}_{i ⊕ 1}^{( 2 )} ‖}_{2} \qquad ( 1 )$$

where n and nₜ are the number of banner pairs and the number of tokens in a mini-batch, respectively. The first term in Equation 1 is the binary cross-entropy loss for token classification. The second term forces the model to generate similar embeddings for matching pairs, while the last term encourages the model to maximize the distance between an arbitrary pair. Note that for the last term, ⊕ denotes circular shift for generating non-matching pairs. Further note that use of embeddings with unit norm to prevent them from growing unboundedly large due to the last term.

The above approach utilizes temporal data (via two snapshots of the same device/service roughly one month apart) to supervise and help the model generate higher quality embeddings. Note that the idea of contrastive training using dissimilar/similar pairs has also been used in other domains. The temporal information further incentivizes the model to generate similar embeddings for different versions/configurations of the same hardware or software product. This makes the embeddings suitable for clustering.

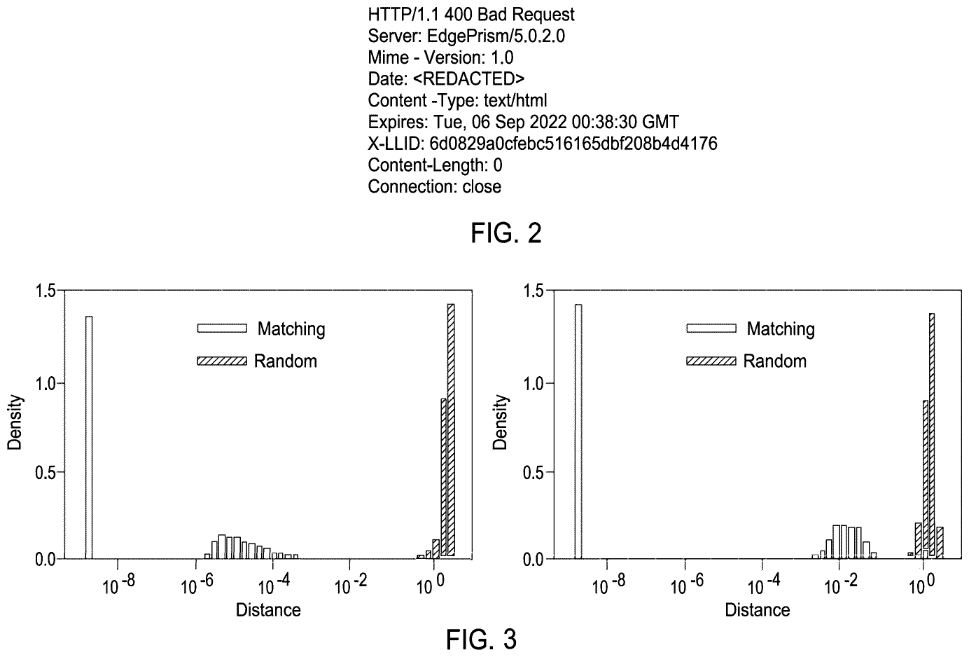

The masked language model can be fine-tuned using the loss function from Equation 1 for 20,000 iterations, a batch size of 1024 (512 pairs), and a learning rate of 0.00005. Over a held-out test set of 100,000 pairs, token classification achieves an accuracy of 98.3%, with precision/recall values of 96.9%/98.9% for positive labels and 99.3%/97.9% for negative labels. This indicates that static/dynamic portions of a banner can be predicted with great accuracy. FIG. 2 shows an example where the output of the model has been used to annotate static/dynamic portions of the banner (with grayed out areas denoting dynamic portion as predicted by the model). Observe that dynamically generated content (e.g., content of the X-LLID header and timestamps) are correctly predicted by the model. Interestingly, the tail of the version is also predicted to be dynamic, which proves to be true in this instance, as the next snapshot has version 5.0.3.0. This owes to the fact that the model is provided with matching pairs during training, allowing it to observe and subsequently predict frequent changes (e.g., minor version updates).

FIG. 2 also demonstrates an important capability of the model by annotating important information in a banner, which in turn results in better interpretability by giving insight into the model's output. This is a direct result of using a transformer-based model which makes it possible to project predictions back onto the original text. This is in contrast to the bag-of-words and autoencoder models, which would result in a loss of interpretability.

Embeddings generated by the model are examined to show their utility for characterizing scan datasets. FIG. 3 displays the distribution of k distances between embeddings of matching and random pairs obtained using the supervised/contrastive model above, as well as the vanilla masked language model. Both plots illustrate a separation between the two sets, with contrastive learning achieving a much more distinctive split. For the contrastive (masked language) model, 97.0% (94.9%) of matching pairs have distances less than 0.1, while 97.8% (99.0%) of random pairs have a distance more than 0.1. The jump in the left side of the plots in FIG. 3 contains pairs with a distance of zero (due to a perfect match between the two banners), accounting for 52.3% of all pairs. For pairs with a non-zero distance, the average and standard deviation of log-distances is −4.58±1.46 (−2.14±0.70) for matching pairs, and 0.22±0.54 (−0.31 ±0.21) for random pairs. One can see that contrastive training results in a three-order magnitude difference in distances between matching and random pairs.

Pairs in FIG. 3 are obtained one month apart. The same experiment is repeated for the beginning/end of the observation window, resulting in pairs that are five months apart. For this longer window, the percentage of pairs with the exact same banner drops to 16.6%, while the percentage of matching pairs with a distance less than 0.1 is 94.7% (91.1% for the masked language model). This shows that supervised training can help attain robust embeddings that are stable over long observation windows.

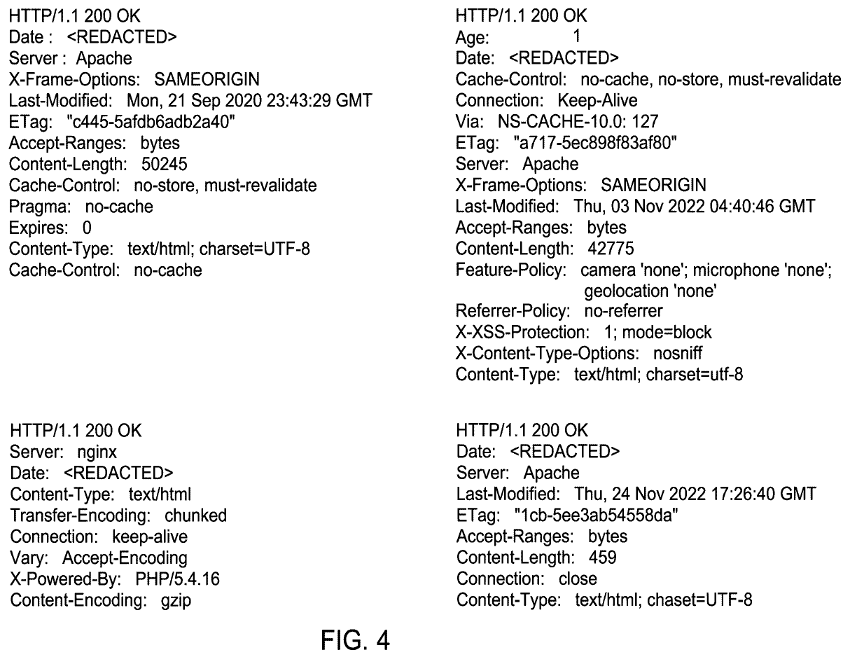

One hundred randomly selected banners pairs with a distance larger than 0.1 were also inspected. For all inspected examples, one can observe that they either correspond to different hardware/software (due to entirely different header content, especially the Server header), or an updated configuration (due to changes in header content beyond simple version updates, e.g, the addition/removal of headers). Examples of these two cases are included in FIG. 4. This shows that distances in the embedding space can be used to detect major/anomalous changes in a host, e.g., due to configuration updates, or when observations correspond to completely different devices. Note that the contrastive loss in Equation 1 reduces the number of false positives (e.g., as compared to a naive approach such as edit distances) by minimizing distances due to expected changes in dynamic portions of the banner, i.e., the grayed out sections in FIG. 2. To further elaborate, the example in FIG. 2 has a distance of 3.6e-4 from its subsequent snapshot despite a normalized edit (Levenshtein) distance of 0.166.

The banner embeddings detailed above capture characteristics of the underlying service and are robust to arbitrary noise that may be present in a banner. To determine whether similar embeddings can be used to identify similar physical devices (i.e., with the same manufacturer and/or model) or server software (with the same vendor/product), one can automatically generate and examine text-based regular expression fingerprints from clustered service banners, as described in the remainder of this section.

To speed up clustering, principle component analysis (PCA) is optionally performed to reduce embedding dimensionality from 256 to 64. PCA is preferably performed prior to the step of clustering. PCA is trained using 5 million randomly selected embeddings. For the selected principal components, the cumulative sum of the explained variance ratio is 99.97%, resulting in minimal information loss.

For clustering, a density-based spatial clustering of applications with noise (DBSCAN) method is employed. More specifically, a hierarchical variation of DBSCAN referred to as HDBSCAN is used for density-based clustering. The original DBSCAN detects areas of high-density surrounded by low-density regions. While DBSCAN requires an epsilon value (the maximum distance for two samples to be considered neighbors), HDBSCAN removes this hyperparameter by trying various values and finding a clustering with the best stability over epsilon. HDBSCAN is preferred because it is designed to handle clusters of varying shapes and sizes (e.g., non-convex clusters that cannot be retrieved with centroid-based methods such as K-Means), and does not require knowing the number of clusters beforehand. Other clustering methods are also contemplated by this disclosure and fall within the broader aspects of this disclosure.

HDBSCAN is trained using 5 million embeddings and settings of min_cluster_size=50 and min_samples=5. HDBSCAN can also be provided with a cluster_selection_epsilon, for which clusters below the given threshold are merged; increasing this value decreases the total number of clusters by preventing the algorithm from generating micro-clusters. Multiple clusterings can be generated by varying levels of granularity and setting cluster_selection_epsilon E {0.01, 0.02, 0.05, 0.1}. The resulting number of clusters and percentage of unclustered outlier are 5452/5.86%, 3989/4.57%, 2138/2.32% and 736/0.63%, respectively.

Different techniques may be employed to generate a fingerprint for a cluster. In the example embodiment, a fingerprint is generated by randomly selecting n samples (e.g., 10) from a cluster and applying longest common substring matching to extract common substrings between all samples. Note that this matching is done on a per-header basis. Next, convert the result to a regular expression (composed of a series of substrings and wildcard expressions), resulting in a single regex pattern per header. Repeat this process by selecting 100 different sets of 10 samples from each cluster, and generate patterns from all four clustering's to obtain a larger pool of fingerprints with different granularities. This process yields 15,718 patterns/fingerprints from all headers, likely to capture physical (e.g., IoT) devices and/or server software.

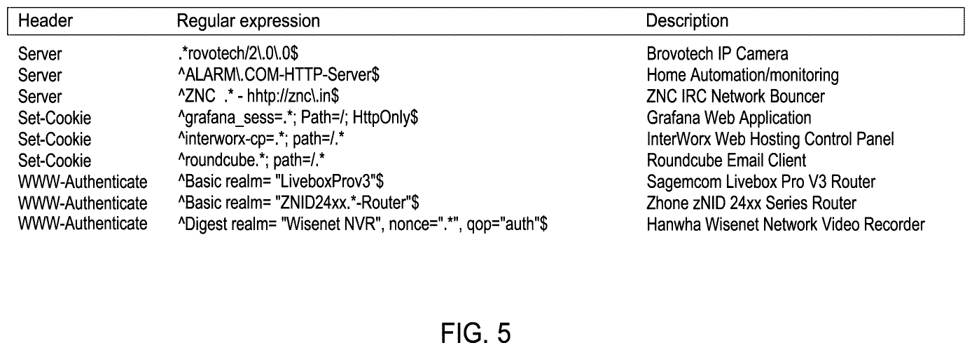

These fingerprints are compared to hand-curated regex patterns from Recog, also utilized by Censys for labeling scan data. First extract Recog fingerprints for the HTTP Server, Set-Cookie, and WWW-Authenticate headers, containing 447, 82, and 77 fingerprints at the time of this writing. Then examine the fingerprints (798, 2478, and 635 for the aforementioned headers), and find fingerprints not captured in Recog. FIG. 5 depicts a table that includes some such examples, etc. This shows that this framework can be used to complement existing fingerprint databases, and can be applied to scan data on a regular basis to keep fingerprints up-to-date.

The number of Recog fingerprints that are recovered using this technique are also examined. First match Recog fingerprints to ours by finding the pair with the highest overlap ratio. Then filter for fingerprints with an overlap of at least 90%, resulting in recovering 117, 9, and 22 of Recog fingerprints for the HTTP Server, Set-Cookie, and WWW-Authenticate headers. One can further observe that the recovered fingerprints account for 98.1%, 63.2%, and 61.2% of all banners that are labeled by Recog for each header, respectively. Additionally, search for partial matches by finding fingerprints that are a subset of a Recog pattern (with >90% coverage). This yields partial matches for 251, 25, and 51 of Recog fingerprints for the aforementioned headers, accounting for 99.3%, 89.6%, and 96.1% of banners labeled by Recog. This analysis shows that the proposed technique is successful at recovering frequent patterns.

This disclosure demonstrates the potential use of LLMs to enable automated analysis of Internet scan data, especially for the purpose of clustering similar devices, as well as extracting hardware/software fingerprints. The ability of transformers to annotate raw text can also be a useful tool for highlighting important information in a banner as shown in FIG. 2. Note, however, that while the generated fingerprints can be used to identify specific products (as shown in FIG. 5), manual validation is still needed to sanitize the associated regex patterns and remove (near) duplicates. As an example, some patterns in FIG. 5 also capture device configuration in addition to the underlying product (e.g., through the “path=/.*” portion of regexes for the Set-Cookie header). In addition, data captured in the wildcard portion of the regexes sometimes contains useful information, e.g., the pattern for Zhone routers can capture different models such as ZNID24xxA1 or ZNID24xxB1.

Further note that while we have only showcased the framework on the HTTP protocol, the same methodology can also be applied to other protocols where existing fingerprints are even more sparse. The proposed technique focuses on temporal stability and the ability to recognize static/dynamic portions of a banner to ensure embeddings are of high-quality. This is achieved by leveraging matching/similar pairs during training to make embeddings invariant to dynamic portions of a banner, while maximizing distances between random pairs. This follows the idea of contrastive learning to create high-fidelity embeddings, an approach that has also been applied to other domains, e.g., to characterize scientific documents and neural recordings. However, this also subjects embeddings to the quality of matching pairs used during training. We use snapshots obtained from the same IP/port to ensure temporal stability, while omitting pairs that likely correspond to different devices/services as discussed in subsection 4.2. Note, however, that the same approach can be used with other techniques for retrieving similar pairs, to generate high-quality embeddings for other application-driven similarity criteria.

In another aspect of this disclosure, fingerprints generated for a network service or product can be used to determine a risk score for that network service or product. First, a fingerprint for a network service or product is generated in the manner described above, where the fingerprint is a text string that describes the network service or product and is derived from a plurality of banners. The text string in the fingerprint is in turn converted to a description for a specific software or hardware product, for example using a large language model.

Next, the description for the specific software or hardware is mapped to a standard name for the specific software or hardware using a vulnerability database. In an example implementation, the description for the specific software or hardware is mapped to a Common Platform Enumeration (CPEs) provided by the National Vulnerability Database (NVD). CPEs are machine-readable unique identifiers for software/hardware products. As an example, the software “Microsoft Internet Explorer 8.0.6001 Beta” is mapped to the following CPE: cpe:2.3:a:microsoft:internet_explorer:8.0.6001:beta:*:*:*:*:*:* Other types of vulnerability databases are contemplated by this disclosure.

A list of vulnerabilities for the specific software or hardware is then retrieved from the vulnerability database. In the context of the National Vulnerability Database, each vulnerability in the list of vulnerabilities is assigned a unique identifier (called a CVE-ID) and a severity score. Continuing with the previous example, searching cpe:2.3:a:microsoft:internet_explorer:8.0.6001:beta:*:*:*:*:* in the NVD search page (https://nvd.nist.gov/products/cpe/search) lists all the CVE-IDs associated with that version of Internet Explorer. A severity score is also retrieved for each vulnerability associate with the specific software or hardware. For example, the severity score may be assigned to the CVE by the Common Vulnerability Scoring System (CVSS) and provided in the National Vulnerability Database. In another example, third-party severity scores, such as the Exploit Prediction Scoring System (EPSS, https://www.first.org/epss), may have a one to one mapping with CVEs.

Lastly, severity scores from the list of vulnerabilities are aggregated together to derive a risk score for the network service or product. In one example, a risk score is computed by averaging the severity scores from the list of vulnerabilities. Other aggregation methods can be used as well, including but not limited to taking maximum score or minimum score as the risk score.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for fingerprinting network devices, comprising:
receiving, by a computer processor, a plurality of banners, where each banner contains text data describing a network service or product accessible at a port on a networked device in a computer network;
generating, by the computer processor, a set of embeddings from the plurality of banners using a large language model, where each embedding in the set of embeddings represents one or more banners from the plurality of banners;
clustering, by the computer processor, the embeddings based on distance between the embedding using a clustering method, thereby forming a group of clusters;
generating, by the computer processor, a fingerprint for a given cluster in the group of clusters, where the fingerprint is a text string from a given banner and identifies a network service or product accessible in the computer network.

2. The method of claim 1 further comprises converting the text string in the fingerprint to a description for a specific software or hardware product and a link to the specific software or hardware product.

3. The method of claim 2 wherein the text string in the fingerprint is converted using a second large language model.

4. The method of claim 1 wherein the large language model is further defined as a masked language model.

5. The method of claim 1 further comprises training the large language model using supervised contrastive learning.

6. The method of claim 1 further comprises performing principal component analysis on the embedding prior to the step of clustering.

7. The method of claim 1 wherein the embeddings are clustered using a density-based spatial clustering of applications with noise (DBSCAN) method.

8. The method of claim 1 further comprises changing a parameter of the clustering method; and repeating steps of clustering and generating fingerprints using the changed parameter.

9. The method of claim 1 wherein generating a fingerprint further comprises
randomly selecting samples from the given cluster;
identifying a text string common to each of the selected samples;
creating the fingerprint using the text string in response to identifying the text string in each of the selected samples; and
foregoing creating of the fingerprint in response to the absence of the text string in one or more of the selected samples.

10. A computer-implemented method for determining a risk score for a network service or product, comprising:
generating, by a computer processor, a fingerprint for a network service or product accessible in a computer network, where the fingerprint is a text string that describes the network service or product and is derived from a plurality of banners;
converting, by the computer processor, the text string in the fingerprint to a description for a specific software or hardware product using a large language model;
mapping, by the computer processor, the description for the specific software or hardware to a standard name for the specific software or hardware using a vulnerability database;
retrieving, by the computer processor, a list of vulnerabilities for the specific software or hardware form the vulnerability database, where each vulnerability in the list of vulnerabilities is assigned a severity score; and
aggregating, by the computer processor, severity scores from the list of vulnerabilities to derive a risk score for the network service or product.

11. The method of claim 10 wherein generating a fingerprint further comprises:
receiving, by a computer processor, a plurality of banners, where each banner contains text data describing a network service or product accessible at a port in a computer network;
generating, by the computer processor, a set of embeddings from the plurality of banners using another large language model, where each embedding in the set of embeddings represents one or more banners from the plurality of banners;
clustering, by the computer processor, the embeddings based on distance between the embedding using a clustering method, thereby forming a group of clusters;
generating, by the computer processor, the fingerprint for a given cluster in the group of clusters.

12. The method of claim 11 wherein generating the fingerprint for a given cluster includes
randomly selecting samples from the given cluster;
identifying a text string common to each of the selected samples;
creating the fingerprint using the text string in response to identifying the text string in each of the selected samples; and
foregoing creating of the fingerprint in response to the absence of the text string in one or more of the selected samples.

13. The method of claim 10 wherein aggregating severity scores from the list of vulnerabilities further comprises computing an average of the severity scores from the list of vulnerabilities to derive the risk score.

14. A non-transitory computer-readable medium having computer-executable instructions that, upon execution of the instructions by a processor of a computer, cause the computer to:
receive a plurality of banners, where each banner contains text data describing a network service or product accessible at a port in a computer network;
generate a set of embeddings from the plurality of banners using a large language model, where each embedding in the set of embeddings represents one or more banners from the plurality of embeddings;
cluster the embeddings based on distance between the embedding using a clustering method, thereby forming a group of clusters;
generate a fingerprint for a given cluster in the group of clusters, where the fingerprint is a text string from a given banner and identifies a network service or product accessible in the computer network.

15. The non-transitory computer-readable medium of claim 14 wherein the instructions further cause the computer to convert the text string in the fingerprint to a description for a specific software or hardware product and a link to the specific software or hardware product.

16. The non-transitory computer-readable medium of claim 14 wherein the large language model is further defined as a masked language model and training is performed using supervised contrastive learning.

17. The non-transitory computer-readable medium of claim 14 wherein the embeddings are clustered using a density-based spatial clustering of application with noise method.

18. The non-transitory computer-readable medium of claim 14 wherein the instructions further cause the computer to generate a fingerprint by
randomly select samples from the given cluster;
identify a text string common to each of the selected samples;
create the fingerprint using the text string in response to identifying the text string in each of the selected samples; and
forego creating of the fingerprint in response to the absence of the text string in one or more of the selected samples.
